(19) United States
(12) Patent Application Publication
(10) Pub. No.: US 2016/0065498 A1
(43) Pub. Date: Mar. 3, 2016

(54) DISTRIBUTED TRANSACTION SUBSYSTEM

(71) Applicant: rift.IO, Inc., Burlington, MA (US)

(72) Inventors: Matthew Hayden HARPER, Salem, NH (US); Timothy Glenn Mortsolf, Amherst, MA (US)

(21) Appl. No.: 14/836,419

(22) Filed: Aug. 26, 2015

Related U.S. Application Data
(60) Provisional application No. 62/042,029, filed on Aug. 26, 2014.
(60) Provisional application No. 62/042,436, filed on Aug. 27, 2014.

(51) Int. Cl. H04L 12/911; H04L 1/16; H04L 29/08

(52) U.S. Cl. CPC H04L 47/826; H04L 67/325; H04L 1/1621; H04L 67/1097

(57) ABSTRACT

Systems and methods are disclosed for managing the state of resources shared among a plurality of network nodes. in an embodiment, a transaction may first be received from a transaction provider. The transaction may target one or more data objects within a communications network. The transaction may be distributed to a first set of data store nodes and network nodes that subscribe to at least one of the targeted data objects. Each data store node may store a plurality of data objects within the network. The transaction may then be distributed hierarchically to a second set of data store nodes and network nodes by the first set of nodes. The transaction may include one or more subtransactions, and the transaction may not complete until each subtransaction completes.

### CROSS REFERENCE TO RELATED APPLICATIONS

This application claims the benefit of U.S. Provisional Patent Application No. 62/042,029 (Atty. Docket No. 3561.0040000), filed Aug. 26, 2014, titled “DISTRIBUTED TRANSACTION SUBSYSTEM,” and U.S. Provisional Patent Application No. 62/042,436 (Atty. Docket No. 3561.0070000), filed Aug. 27, 2014, titled “CLOUD PLATFORM FOR NETWORK FUNCTIONS,” both of which are hereby incorporated herein by reference in their entirety.

### BACKGROUND OF THE INVENTION

1. Field

This field is generally related to managing shared resources in a distributed networking environment.

2. Background

Cloud networking environments often use distributed atomic transactions for their processing. Distributing transactions among many nodes achieves more efficient use of computing resources. However, scalability problems arise as the number of nodes and transactions grow.

A typical solution used in network management software is to have a single controller distribute the processing of a transaction to network elements. However, this model can lead to inefficiencies as the number of nodes in the network becomes sufficiently large. Additionally, many current solutions do not provide acknowledgements back to the controller from network nodes, leaving the characteristic of network consistency difficult to determine.

A transaction within a networking environment may also need to be modified during execution of the transaction. Many current solutions address this issue by creating additional transactions, but this can make network consistency even harder to maintain by failing to address the dependencies and context of each additional transaction. Therefore, what is needed is a solution that addresses these issues while maintaining scalable efficiency.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram depicting a typical cloud networking environment, according to an embodiment.

FIG. 2 is a diagram depicting an example system for executing and distributing a transaction among a plurality of subscribing network nodes in a cloud networking environment, according to an embodiment.

FIG. 3 is a diagram illustrating an example method for originating a transaction and preparing the transaction for execution in a cloud networking environment, according to an embodiment.

FIG. 4 is a diagram illustrating an example method for originating a subtransaction and preparing the subtransaction for execution, according to an embodiment.

FIG. 5 is a diagram illustrating an example method for determining whether to execute a transaction rollback, according to an embodiment.

FIG. 6 is an example computing system useful for implementing various embodiments.

The drawing in which an element first appears is typically indicated by the leftmost digit or digits in the corresponding reference number. In the drawings, like reference numbers may indicate identical or functionally similar elements.

### DETAILED DESCRIPTION OF THE INVENTION

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example of a Cloud Networking Environment

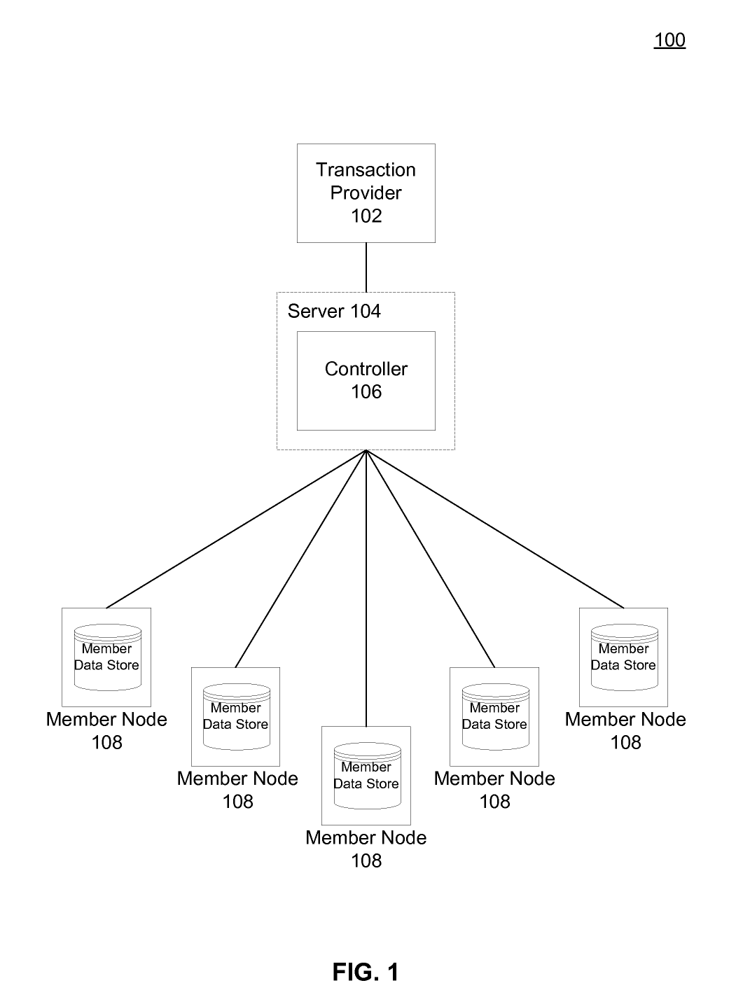

FIG. 1 is a diagram depicting a typical cloud networking environment, according to an embodiment. System 100 includes transaction provider 102, server 104, controller 106, and a plurality of network member nodes 108. Changes to resources within system 100 may require communication to maintain data consistency across the plurality of member nodes 108. Transaction provider 102 may provide transactional instructions to a controller 106 in order to communicate changes to each of member nodes 108. For example, a transaction may be provided to controller 106 from a network administrator via a command-line interface.

In a typical embodiment, controller 106 may then prepare and distribute the transaction to each of member nodes 108. While this architecture may perform adequately for a small number of member nodes, large inefficiencies may occur as the number of network nodes becomes sufficiently large. To combat these inefficiencies, multiple controllers may be introduced to load balance the system, but coordination and transactional consistency must then be maintained. Embodiments described below address these issues by providing systems and methods for hierarchical distribution of transactions while maintaining transactional consistency through transaction dependencies and communication between network nodes.

### Example Hierarchical Transaction Distribution

Embodiments described herein provide a system to manage the state of resources shared between two or more distributed software components. The software components may be distributed across multiple network nodes in a communications network, requiring communication between components to maintain data consistency. This inter-component communication may be used, for example, for a resource allocation request, in which a request is made by one software component to obtain a resource from another software component. For example, one type of resource may be an IP address. In the case of IP address allocation, a subscriber management software component may allocate IP pool dynamic addresses from an IP address pool software component. The state of the IP address allocation may then be replicated across both objects, including any running software redundancy components.

In another example, a resource may be a datapath IP flow. In such a case, a subscriber management software component may make requests into the datapath software component to install IP flows for the subscriber IP address assigned to each of the subscriber dataplane bearer sessions. In some cases, the state of the IP flow may be partially replicated across both objects. The datapath software component may then maintain the state of the IP flow installed by the subscriber management component. For example, both the subscriber management component and the datapath component may each replicate the flow ID in respective object databases. Object databases of different software components across multiple network nodes remain synchronized in this manner.

In an embodiment, a replicated object database may also be used in a variety of cases in which a software component manages the state for a data object that must be visible to other software components. For example, in an embodiment, network management software components may create VPN network contexts as they are stored into the system configuration database. Each network management software component that creates a VPN context may then publish the name of the VPN context and the assigned VPN context ID to a replicated object database. Thus, other components that require the information contained in this mapping may subscribe to the database or data objects contained within the database to receive replicated copies of the VPN network context database state.

In another example, log management software may place logging directives that may determine how to filter and manage log messages into a distributed object database. The logging client software component may then subscribe to this database to obtain a replicated copy of these log settings, so that it may perform logging operations.

Various embodiments described herein may also provide a transactional API for reading and changing configuration and operational data, a general purpose distributed data store available as a replication target and/or transaction participant for member nodes not themselves providing replication or state storage, a replication API suitable for various types of data replication and recovery, an audit API suitable for identifying state mismatch and driving reconciliation code, and a simple parameterized resource manager that is able to assign and reclaim ID numbers, items from a list, or other resources.

In order to manage resources across many different software components and network nodes, network queries and inter-component communication must be executed in an efficient and transactionally-consistent manner. In a traditional database, a single object may add/delete/update a single horizontal role in a table using either an embedded client API, or a protocol that performs a remote message transaction with a separate database process. In embodiments described herein, a database may allow multiple components to update a horizontal row as part of a single transaction. For example, consider how an IP address allocation may be managed for an IP address pool. In such a case, each IP address pool may be managed in its own database table for that object. The database service contact information for that particular IP address database table may be managed within the name service. A transaction for an IP address pool allocation may begin when a session manager performs an IP address allocation by creating a new entry in an IP address resource table, which contains the session ID. The IP address manager may then complete the database transaction by filling in the IP address in that entry. The transaction may not be considered complete until each member node has played its part to fill in information in the entry and the information has been received by all members that have subscribed to the database table.

Embodiments described herein may provide transactional consistency and efficiency by enabling multiple members/components to be involved in a single transaction, requiring receipt and acknowledgement by all components before designating a transaction complete, and rolling back transactions not acknowledged by all subscribing components to targeted data objects within the transaction.

A transaction is a complete top-level operation requested by an external or internal entity. It is transactional in the sense that it may be entirely applied, or entirely not applied. According to an embodiment, each transaction may be composed of an ordered list of subtransactions. Each subtransaction may be completely formed prior to execution of the top-level transaction or during execution of the transaction.

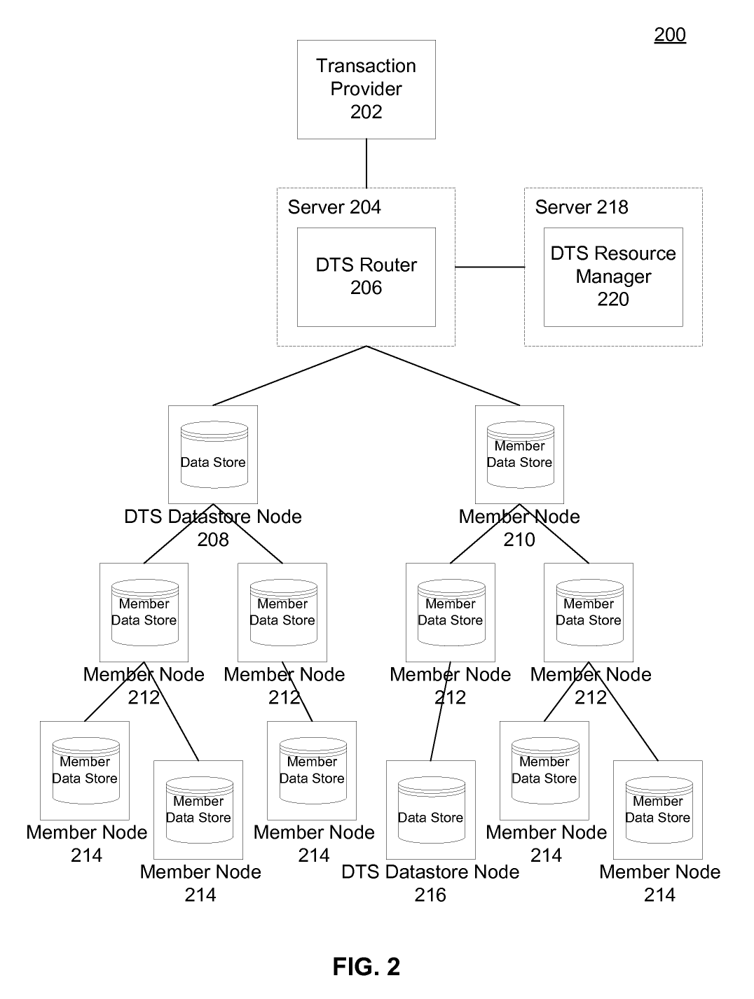

FIG. 2 is a diagram depicting an example system 200 for executing and distributing a transaction among a plurality of subscribing network nodes in a cloud networking environment, according to an embodiment. System 200 may include a transaction provider 202. Transaction provider 202 may provide a transaction to a local DTS Router 206. According to an embodiment, queries may be routed by local DTS Router 206 and executed in a Member API of participating member nodes. DTS Router 206 may be a transaction router providing functions that actually distribute and execute transactions within system 200 by registering with a Member API of participating member nodes and implementing the needed callbacks.

A transaction provider may be internal or external to system 200. For example, a transaction may be provided external to the system via a command-line interface or a web application user interface. Alternatively, a transaction may be created by a system component and sent to DTS Router 206. In an embodiment, DTS Router 206 resides on a server 204 within system 200. System 200 may contain a plurality of DTS Routers 206, which may reside on server 204 or different servers within the system. In an embodiment, transaction provider 202 and server 204 are connected via a network, such as a wide area network (WAN), for example the Internet, or a local area network (LAN). In another embodiment, transaction provider 202 and server 204 may be implemented on the same computing system and/or device. DTS Router 206 may also be coupled to DTS Datastore nodes and member nodes 208-214 via one or more networks, such as a WAN or LAN.

DTS Router 206 and network nodes 208-214 may be part of a cloud networking environment, such as a distributed and/or virtualized enterprise network environment. The transaction may target one or more data objects within the network in a hierarchical manner. DTS Datastore nodes 208 and 216, as well as member nodes 210, 212, and 214, may be subscribers to one or more of the data objects targeted in the transaction. When distributing a transaction to subscribers, DTS Router 206 may determine one or more nodes to first send the transaction to As illustrated in FIG. 2, in this example, DTS Datastore node 208 and member node 210 may first receive the transaction. These members in turn may distribute the transaction to other member nodes 212, which in turn may distribute the transaction, to member nodes 214 and DTS Datastore node 216. This hierarchical distribution helps to improve efficiency by reducing the load on the local DTS Router 206. Acknowledgements from member nodes may be populated back up the distribution tree to the distributing DTS Router 206. In another embodiment, DTS Router 206 may send the transaction directly to all nodes 208, 210, 212, 214, and 216.

DTS Datastore nodes 208 and 216 function similarly to normal member nodes of within the network, but they may be used to store system checkpoints at a particular point in time and for audit purposes, as will be discussed further below. DTS Datastore nodes 208 and 216 (also referred to herein as data store nodes) may include any type of structured data store, for example a relational or document-oriented database. In an embodiment, these data store nodes may act as an authoritative source for pending and committed states of data objects within system 200 to ensure transactional consistency.

System 200 may also include a DTS Resource Manager member 220 that resides on server 218. In an embodiment, servers 204 and 218 are connected via a network, such as the Internet or a local area network (LAN). In another embodiment, servers 204 and 218 may be implemented on the same computing system and/or device, or DTS Router 206 and DTS Resource Manager 220 may be implemented on the same server. DTS Resource manager may register as the default route for data objects within the system. Hence, when an object is to be deleted, a transaction may be distributed to DTS Resource Manager 220, which in turn returns the object's allocated resources to the available resource pool.

Regarding data retrieval transactions, matched values(s) may be appended to and/or aggregated with the subtransaction results. Alternative to merely retrieving values, each key match may be the object of an associated update instruction.

Regarding update transactions, each individual update may trigger either the automatic publication of a data change to subscribers, or application code may execute a subtransaction as part of the implementation of any query. Code-originated subtransactions may execute within the context of the currently running subtransaction. Subscription-originated subtransactions may take the form of ADVISE subtransactions added to a queue to be run in subscription priority order after the currently executing subtransaction, where ADVISE indicates to subscribers that the data has changed, but subscribers may need to explicitly query the specific values needed.

Subtransaction queries of data altered by the current transaction may return the new altered results. This permits subscribing nodes to observe arbitrary side-effect data changes with follow-on queries under the umbrella of the active subtransaction(s) in the current branch and, upon subtransaction completion, in the overall transaction's tentative state.

In an embodiment, a DTS Router may implement forms of multicast message delivery. Arriving transaction requests which require delivery to multiple destinations may be replicated and sent out as new messages. Requests which need hierarchical delivery may have delegates assigned and/or discovered by the router.

Requests that are multicast to a series of local destinations may have a number of interim responses returned; similarly queries that match multiple objects in local members may return multiple interim responses from each.

In an embodiment, aggregation of transactions may be supported for data objects that share the same database destination for the shard to which those objects belong. This reduces transaction overhead and the amount of messaging performed.

In an embodiment, each transaction may specify a maximum time allowed before the aggregated transaction may be dispatched. In an embodiment, each transaction in an aggregated transaction may have its own result status. Accordingly, an error for a single transaction typically does not affect the errors of other transactions aggregated into the same message. In addition to aggregating transactions for dispatch, transaction responses may also be aggregated.

According to an embodiment, a router may also perform necessary cursor functions.

In an embodiment, interim results may be passed all the way back to the client API. When the last sub-request has returned all interim responses and the final response, the router may flag its last response as final, The final response may be a void non-response, indicating only the end, in the case where the final member returned no results.

To improve scaling efficiency, in an embodiment, requests to a non-unicast destination set may be first sent to a random member, and then to additional member(s) in parallel. The amount of parallelism may be inferred on an ongoing basis from the size of the ongoing interim results. Thus, if the initial member returns many results, fewer members may be queried at once. If results dwindle, more members may be queried.

In a further embodiment, requests to any nontrivial database shard may be delegated using an N-way tree structure. If, for example N=2, half of the chunks may be delegated to one child router and the other half to another. These child routers may in turn delegate further until the needed destination or chunk count is small enough.

The delivery scheme need not require that the full set of shard members be known up front. Each child router involved may identify the specific designated shard members, or may in turn delegate further,

### Example Data Object Storage Models

There are a variety of mechanisms that may be used, in various embodiments, to store data objects within the network. In an embodiment, embedded databases may be used, Embedded databases may store database objects in a library within the same process. Some embedded databases, such as SQLlite, for example, support a virtual table concept that allows an application to provide callback functions for the queries and updates to an individual database table, allowing the storage of the object to reside entirely within the application.

In an embodiment, a remote database may be used. A remote database communicates with a client through a messaging protocol that carries database transactions. In this case, the database objects are stored in a separate process. Database transactions may be managed similarly to message processing for messaging protocols that use a separate message broker.

One advantage to using an embedded database is increased performance and simplicity. Of course, an embedded database may also be accessed over a network so that object notification and replication can be performed. One advantage to using a remote database is isolation of the software and threading model from the application software.

In an embodiment, a database table may be broken into several database shards. Database sharding is a technique used to divide a database table into multiple horizontal partitions. A horizontal partition may be a collection of rows from a database table. Methods such as consistent hashing may be used to perform automatic sharding of a database table. Each horizontal partition may then form part of a database shard. These shards may be located in separate database processes or even on separate database servers. in an embodiment, a database may support sharding of horizontal rows, automatic sharding of data, the ability to split shards into N shards (where N>1), and the ability to reduce N shards (where N>1) to fewer or one shard.

Sharding evaluation may occur as part of query routing and transaction distribution, as discussed above. In an embodiment, sharding may occur with any key in a path. it may be used to collapse all registrants of a particular key into a single registration node with a 1:1 mapping of keys to destinations, as well as for sealable item distribution and simple de-multiplexing and resource allocation functions.

In an embodiment, the primary key may be well sharded. Secondary keys may be sharded as well, thus giving two registrations for a single chunk. A chunk is a unit of shard management. A shard-chunk is a further routable division. Chunks may move as a function of registration changes. This may function as a mechanism for shard splitting and combining, and for some shard functions, arbitrary load balancing.

Sharded keys, when encountered, may be resolved as follows, according to an embodiment:

First, apply the function listed in the Sharded Registration Property. This function may be a table lookup, hash function, range selector function, identity for numerical values, or any other function that may yield a chunk number for the sharded key or a miss.

Next, perform a lookup in the shard table for this key's chunk number. In an embodiment, the result may be a reference to a specific destination for the chunk. The result may also be a subtable/tree indicating a subset of registrations to consider for further evaluation of the overall key. In an embodiment, the lookup may then continue using the subtree until the next sharded key or a concrete result is encountered. The result may also be a flag indicating a miss. in an embodiment, if one or more default chunk destinations are registered, route there. If not, a random/weighted/etc. chunk may be chosen. The default or randomly chosen destination may accept or N/A the query: In the accept case, the destination may transactionally install a new chunk entry in the lookup table or a new chunk range registration; in the N/A case, the query router may select another random destination.

In an embodiment, a publish-subscribe communication mechanism may be applied to each database table, and a database may support a publish-subscribe API. For example, software components that use a database table may subscribe to that object to receive notifications about additions, modifications, and deletions to the table. Some member network nodes may both publish and subscribe to the table, while others may only subscribe to the table.

One or more member nodes within the network, according to an embodiment, may be a shardable, in-memory database, referred to herein as a DTS Datastore, used for storage of data interfaced to the system. A DTS Datastore may be “free” in the sense that a single code implementation may be fully parameterized to accept arbitrary types of data in arbitrary sharded subset and peering configurations. In an embodiment, a DTS Datastore may be a standard, ACID-compliant native XML database that may also be able to store objects as Protocol Buffer (Protobuf) blobs.

As described previously, another member node within the network, according to an embodiment, may be a fully parameterized resource manager that is registered as the default destination for unroutable shard chunks or unsharded, unregistered destinations, herein referred to as a DTS Resource Manager. A DTS Resource Manager may implement basic resource allocations, ID assignments, and query redirection subtransactions. This may be used to hand out and reclaim resources in response to query routing misses or explicit requests.

Any keyable item in the data model may have publications or subscriptions registered against it. Several flavors of keying may be available through a query API and a member API, which are discussed further below.

In an embodiment, pubs (i.e., publications) and subs (i.e., subscriptions) may be generated via an API call. Certain tasks may publish or subscribe to data in a parameterized manner based on manifest or other platform data. For example, a DTS Datastore may include generic code that can be executed to act as a secondary publisher of any data.

Publication entries may represent tasks that have a copy of the data. For example, for any given data item there may be a single publisher of priority zero that is considered to implement that data. Data with no publishers may be observed not to exist. Data with no priority zero publisher may be considered to exist, but not currently active; it may then be presumed that the primary publisher will recover and re-implement the data soon.

Subscription entries may represent tasks that wish to implement side-effect behavior any time the data items which they are subscribed to change.

Application-generated requests may be routed to publishers. Actions taken at publishers may trigger the publication of updates to subscribers. Subscriber updates may be originated at or on behalf of the publisher from the publisher's local DTS Router. Subscriber notifications may be sent out after completion of any local router subtransaction queries, but before the SUBCOMMIT (if any) of the subtransaction which triggered them. Subscriber notifications must return, successfully, before the subtransaction may SUBCOMMIT.

Both publications and subscriptions may have numerous properties attached at registration time, for example and without limitation:

Ready—In an embodiment, each pub or sub has a ready value. Registrants that are not ready may not receive queries. Whether this delays, fails, or does not affect transactions referencing non-Ready registrants may be a function of the Optional and Wait properties.

Priority—In an embodiment, each pub or sub may have a priority value. Routing may consider priority values when a key evaluates to more than one destination. In this case, the destination(s) may he queried serially in priority order, with priority 0 first. Items with like priority may be queried in parallel. This is not to be confused with per-query priority values, which define a “phasing” between the individual queries of a subtransaction.

Master/Slave—Some items may be implemented in multiple locations. in an embodiment, the master and slave properties permit individual registrants to take on the master or slave role for the registered keys. This is intended as an implementation convenience to provide backup database semantics.

According to an embodiment, master/slave may be implemented by sending queries to the master first. Slaves may then be sent the query after the master has passed the PREPARE phase. Slaves may be assumed to respond the same way to the PREPARE phase, therefore transaction processing may continue in parallel up to the beginning of PRECOMMIT as an optimization. Should a slave respond negatively to an update operation, the top-level transaction may be caused to abort. The DTS Router may implement special logic to promote a slave to master should the master go away.

In an embodiment, the router may classify the registrations using the following flags:

Optional—Some registrations may be flagged as optional. Without this flag, all routed registrations may be required to be executed for a transaction to succeed. This flag may be used to avoid issues stemming from failure of nonessential tasks, or to implement best-effort features like unreliable replication.

Static—Some registrations may be flagged as static. These registrations may have been populated via manifest or other bootstrap logic, and will remain indefinitely. Static registrations may contain no actual destination. Static registrations also may not go away when their destination or registeree goes away. This provides for failure results for items which have no routable destination. Static registrations may also specify the Wait property which may be used to delay until a static entry (or other entry) is routable.

Wait—Queries to destinations with this flag may wait if the destination is unresolvable.

In an embodiment, registrations may also include an update verb as a property. This mechanism may be used to subscribe to only create or delete events for an object.

According to an embodiment, each registration (both subscriptions and publications) may have a block of sharding properties. Typically, most objects may be sharded; unsharded items may simply have a notional sharding function of 1 and one chunk.

Members may register for sharded paths using a wildcard and a list of chunk ranges. In the routing table, all like sharded paths may be collapsed and the chunk ranges may be combined into a single chunk lookup table, one for each set of leading keys chunk-ranges.

The actual shard function to be used may be found in a sharding property. Functions may include IDENT (pass through of key value as chunk number), TABLE (lookup of chunk values 1:1 from key values in a table kept as a bolt on to routing data), and HASH (a parameterized general purpose hash accepting a (function, bits) triple as parameters to turn the key into chunk numbers).

There may be a dedicated default (e.g., “miss”) chunk registration coupled with various shard routing properties to support redundant and/or load balanced de-multiplexing behavior. The default registration may point to a fully parameterized generic resource allocator task provided as part of the system.

Operational data transactions may be used by application code to replace arbitrary ad-hoc message passing sequences for application functions. Application code may publish items which it owns. When an item has a state change, the state change may be implicitly published. Subscribers may implement side effect behavior via a series of notifications delivered in priority order, a series of code-originated side effect transactional subqueries, or any mix of the two.

In an embodiment, a naming service may be provided that maps a representation of a service name, such as, and without limitation, an ASCII representation, into internal contact details of the services that manage the specified service transactions. A database may also support the partitioning of database tables into separate tables that can be individually addressed by the name service.

In an embodiment, a plugin API may be used with the name service. For example, the plugin API may provide functionality for publishing name service entries for each database table. The plugin API may also provide functionality for a subscriber to lookup name service entries for each database table.

In an embodiment, there may be a column in a database table that uniquely identifies each record in the table, referred to as a primary key. In some cases, primary keys may be formed from the combination of two or more columns, in which case the primary key may be referred to as a composite key.

Database tables may sometimes be linked together with a foreign key. Foreign keys are not typically required to be unique in the table that stores them, but they may point to unique rows in a referenced table. For example, a session database table may use a session identifier as the primary key to the session database table, The network context identifier of the IP bearer session may be a foreign key into a network context table. There may be multiple sessions in the session database table that share the same network context identifier key for session bearers that share the same network context; however, according to an embodiment, only one row in the network context table is present for each network context identifier. The network context identifier may be a foreign key in the session database table that points to a primary key in the network context database table. Lookup operations may be performed based a primary key, a foreign key, or other lookup criteria.

A database may support lookup of objects through primary and foreign keys. In various embodiments, a database may also support abilities to query field values, perform SQL-based queries, and perform XPATH-based queries.

In an embodiment, new software components that are started in a network may need to obtain the replicated state of any database shards that they subscribe to. Thus, the database may provide a mechanism to replicate the state of the entire database shard into a new component that is started and has requested a copy of the database.

Periodic audits may be performed across each member of a shard to ensure that they have proper and up-to-date copies of the database. A first level audit may compute a signature across the entire active dataset, such as a hash, to verify that all components in a shard have a consistent view of the objects stored in that database shard. If that audit fails, then a deeper level object-by-object audit may be performed to bring all the members of the database shard into a fully consistent state.

An audit may occur on a shard-chunk basis between application publishers and the subscribing DTs Datastore, however an audit may also occur between arbitrary publishers and subscribers that share a common set of data, According to an embodiment, an audit may be performed based on computed signatures of objects and/or transactions, or alternatively by performing a more comprehensive object-by-object comparison. In an embodiment, a set of auto-auditing configurable parameters may be defined.

According to an embodiment, both publishers and subscribers may keep a set of checksum values to assist in audit and recovery operations. Checksums may be kept on a per-object and per-shard-chunk basis. Each record/object may have a computable checksum. An order-sensitive CRC-themed checksum or hash function may be used, in an embodiment, as this computation can be one way and not incremental, and is reasonably robust against arbitrary differences/corruption.

Each transaction may have a checksum computed, which may be the plain sum of the object checksums of all affected objects. The plain sum is used as there may be no defined ordering to object alterations within a transaction-induced state change, thus, all objects may be considered to have changed at the same time. For audit purposes, the plain sum of the pre-transaction value of all affected objects may also be computed. For transaction checksum computation purposes, objects that do not exist (e.g., objects that were just deleted or created) have a record-level checksum value of zero.

Each shard chunk may have a full chunk checksum defined as a checksum of the chunk's individual object checksums. This checksum may be incrementally updated with each operation to reflect the current full chunk checksum. This full chunk checksum may likewise be incrementally unwound to a pre-transaction state, given the before and after object checksums for object(s) impacted by a transaction.

In an embodiment, a series of such full chunk checksums may be kept, one for each previous state of the chunk, dating back for the maximum reconciliation/audit time window needed. For each historical chunk checksum, the transaction ID may be kept. In the publishing member, the before and after object checksums may also be maintained with each transaction in the history list.

According to an embodiment, the quick audit sequence involves the publisher requesting a block of recent full chunk checksum values and IDs from the subscriber, plus the list of recent transaction IDs and object checksum tuples.

According to an embodiment, a full audit makes an explicit comparison of subscriber state versus publisher state. This may be implemented to support any subscriber and publisher paired via shard chunks in a 1:1 relationship.

The full audit may be a streaming exercise in which all objects are retrieved from the subscriber (e.g., the Datastore) in a defined order. Each object may be compared directly, not as a checksum, and then the next is considered.

Objects which are added or modified may be marked as dirty and recorded in a journal in both the subscriber and publisher once the process has begun. After reaching the end of the first iteration over all objects, the audit process iterates over the set of changed objects until this set becomes sufficiently small. At this point, the publisher may cease commit operations until all outstanding commits in the chunk complete in the subscriber. When there are no outstanding commits, the publisher and subscriber should be in sync, and the audit may conclude.

As a side effect, the audit process may compute a synchronous full chunk checksum value that may match as of the moment the audit ends, as well as flush the list of historical transaction checksums and before/after object checksum data.

Reconciliation may be layered atop full audit. The database is intended to be authoritative, so a reconciliation may involve an audit which corrects the application state accordingly as the sequence runs. According to an embodiment, the implementation may accumulate but not begin executing a corrective transaction for differences found. Once the audit completes, the corrective transaction may he immediately executed locally only (or, in an alternate embodiment, locally and to all subscribers NOT including the database) in order to reconcile the audited members.

### Example Method

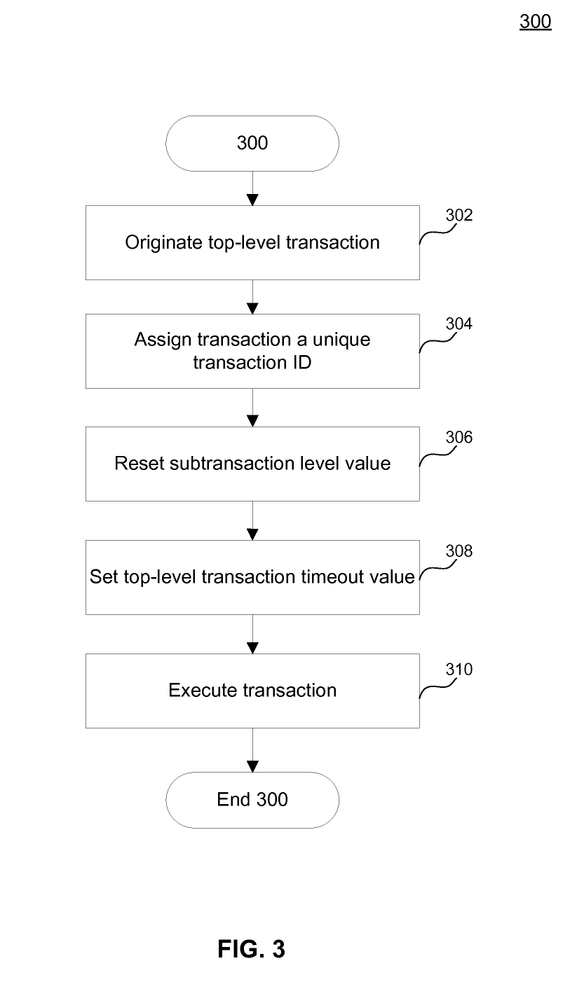

FIG. 3 is a diagram illustrating an example method for originating a transaction and preparing the transaction for execution in a cloud networking environment, according to an embodiment. At step 302, a top-level transaction is originated. Transactions may emerge from a transaction originator, such as but not limited to, a transaction router, for example DTS Router 206 of FIG. 2. The transaction originator may execute various preparatory steps, according to the embodiment. At step 304, the transaction originator may assign a unique transaction ID to the transaction. Next, at step 306, the originator may reset a subtransaction level. The subtransaction level may be used to ensure the top-level transaction is not applied to affected network nodes before associated subtransactions are competed. At step 308, the originator may establish a top-level transaction timeout of N seconds. N may be set manually or determined automatically by the DTS Router, The transaction timeout may be used to determine whether an error has occurred, for example if acknowledgements have not been received from all required network nodes with the time limit specified by the transaction timeout.

Finally, at step 310, execution begins by executing the first subtransaction of the top-level transaction. in an embodiment, top-level transactions may use a three phase commit protocol. The precommit and commit phases of the top-level transaction provide additional robustness against partition and permits trivial implementation of streamlined sub-faux-transaction model.

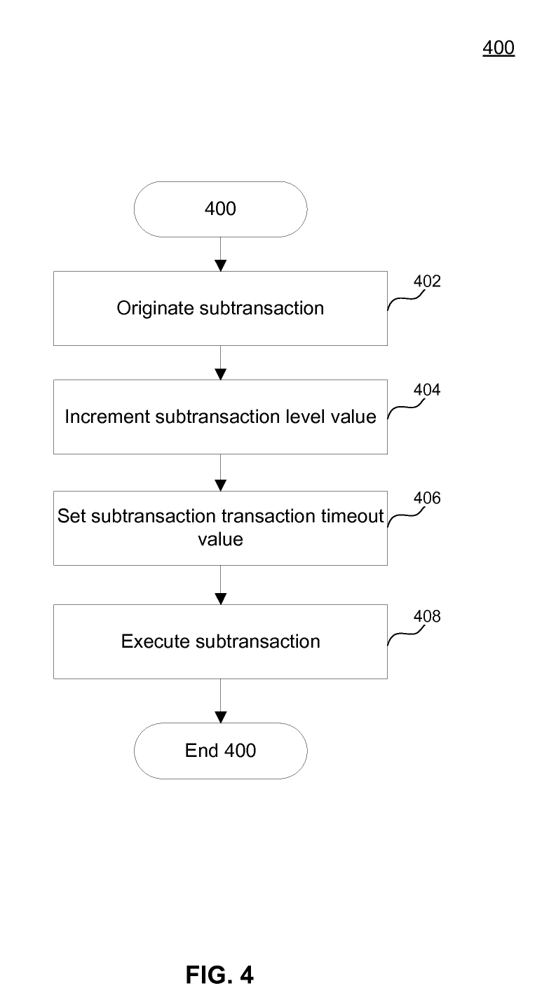

FIG. 4 is a diagram illustrating an example method for originating a subtransaction and preparing the subtransaction for execution, according to an embodiment. At step 402, each subtransaction may be coordinated and originated by a subtransaction router, such as a local DTS Router 206 of FIG. 2. In various embodiments and scenarios, the top-level transaction router and the subtransaction router may be the same or different DTS Router 206. In an embodiment, at step 404, the subtransaction router may prepare for the subtransaction by first incrementing a subtransaction level value. This level may be used to maintain a dependency hierarchy of subtransactions for determining when each subtransaction can be committed and completed. At step 406, the subtransaction router may establish a subtransaction timeout value of slightly less than the remaining time in the top-level transaction. Finally, at step 408, the first subtransaction may be executed.

In an embodiment, subtransactions may use a two phase commit protocol. This is sufficiently robust within the context of a top-level three phase commit. Individual subtransactions may elect to execute as phaseless queries within their containing (sub)transaction's view.

Each Subtransaction may contain multiple queries. Queries may be data lookups, data updates, triggered subscription notification operations, as well as certain bolt-on actions such as remote procedure calls (RPCs). Each query may be a tuple of a key, verb, optional value, and optional adverb/flags.

The queries within a subtransaction need not be ordered; conceptually they may execute in parallel. However, a deterministic query execution ordering may be determined. For example, the data model may contain decorations dictating dependencies between nodes. These dependencies may be translated into ordering at subtransaction query routing time. Alternatively, registrations may include a priority property. Queries that evaluate to multiple destinations may be delivered in a registration priority-defined order. In another example, application bootstrap actions may implicitly generate an ordering when routing delays query execution to wait for application readiness.

Each subtransaction's changes may not be visible outside of the subtransaction context until the subtransaction is committed. Once the transaction is committed, the subtransaction's changes may become visible to participants in the containing subtransaction. As subtransactions commit, their changes may be collapsed into the containing subtransaction's tentative state. When a top-level subtransaction completes, its end state may become the current top-level transaction state.

When the final top-level subtransaction completes, the overall transaction may be committed, which in turn may collapse the entire top-level tentative transaction state into the currently executing state in all participants. This commit need not be synchronous across the system; however, it is guaranteed to produce a consistent state within each participant, and a mutually consistent state among all participants with regard to the affected data.

Subtransactions may be issued with a non-transactional flag, in which case they may execute against the pending state of their containing subtransaction or top-level transaction and may have no SUBCOMMIT phase. The individual queries are executed and any one query NO vote may trigger an ABORT of the entire containing subtransaction or top-level transaction. The top-level transaction may be issued with a non-transactional flag, in which case the entire operation may simply include a series of groups of queries to be evaluated.

When a subtransaction is executed and distributed to the appropriate member nodes, the subtransaction router may respond to member node responses in the following ways, according to an embodiment: Members which returned N/A may be immediately pruned from the query list. If zero members returned No, a SUBCOMMIT message may be sent to all members that did not return N/A. If zero members return an error from the SUBCOMMIT message, a Yes response may he returned to the upstream subtransaction router. If any members returned No, or return an error from the SUBCOMMIT message, the subtransaction may be aborted. In this instance, a SUBABORT may be sent to any subtransaction members that have not been sent a SUBCOMMIT. The router may return a No vote upstream, and the containing (sub)transaction may abort and/or retry.

Read-only transactions may execute in a similar manner as previously described, except that SUBCOMMIT, PRECOMMIT, COMMIT messages and related states may not exist. Instead, a series of queries may be executed against a state snapshot captured at initial query time. The scope of the snapshotted state is member-specific; it might include cache of query cursor state, an atomic copy of an individual highly dynamic item's status, or it might include nothing at all. Completion of the final subtransaction query may trigger an ABORT message to all participants to flush out any snapshot/cache state. Read-only transactions may trigger subtransactions, but cannot trigger update (e.g., write) query actions; attempts to do so may result in a transaction failure.

According to an embodiment, each subtransaction may occur within the context of the containing subtransaction or top-level transaction. Thus, each subtransaction has an independent pending state. This state may be conceptually implemented as a sparse tree in the distributed DOM of just the nodes altered relative to the parent subtransaction or top-level transaction.

Implementation interaction between simultaneous transactions attempting to alter the same data need not be expressly defined, and in an embodiment, the end result of the two transactions may be ACID-compliant. When at least one colliding transaction completes, there may be no interim active state reflecting uncommitted data. Colliding transactions may both complete if the participant can guarantee correct data at all points. For example, consider two transactions that attempt to “Set Dial Tone to Purple.” in such a case, this pending dial tone state may be noted, conceptually with a reference count of two, and both transactions may proceed. Similarly, if one transaction attempts “Set Dial Tone to Purple” and another transaction at the same time attempts “Set Dial Tone to Green,” both may proceed beyond the query phase if the application is able to manage multiple simultaneous tentative states and is prepared for the denial of one or the other subtransaction's SUBCOMMIT message or the top-level transaction's PRECOMMIT message.

A subtransaction commit may collapse the subtransaction's pending state into the pending state of the containing subtransaction. Commit of a topmost subtransaction may collapse the subtransaction state into the top-level transaction's pending state.

A top-level transaction commit may collapse the agreed top-level pending state into the currently running state. Failure of a top-level commit operation may trigger audit, reconciliation, death, and/or recovery of participants. This is one reason for the existence of the PRECOMMIT phase in the transaction state machine.

In an embodiment, an error may occur during a database transaction that may require recovery operations to be performed in order to undo the transaction. This operation is commonly referred to as transaction rollback. In some cases, errors may occur when a database transaction is being performed that is not allowed, such as when an attempt to allocate a resource that is already in use. Other errors may occur during communication, for example when acknowledgements may not be received from all subscribers to a database object during a defined time period. Error codes may be used to indicate why a transaction rollback has occurred.

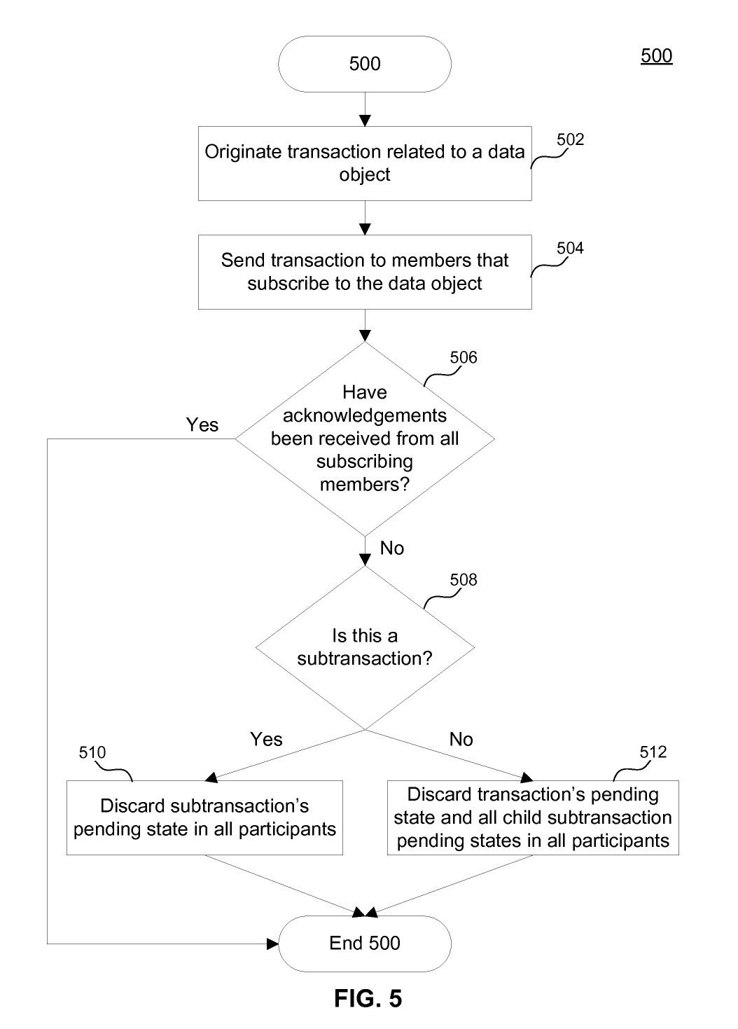

FIG. 5 is a diagram illustrating an example method for determining whether to execute a transaction rollback, according to an embodiment. Method 500 begins at step 502 by originating a transaction related to one or more data objects. At step 504, the transaction may be executed and sent to all member nodes that subscribe to the one or more data objects. In step 506, it is checked whether acknowledgements have been received from all subscribing members, and if so, the method ends. If not, and the transaction timeout value has expired, the method may determine that a transaction abort and rollback is necessary and proceed to step 508. In step 508, it is checked whether the transaction in question is a subtransaction. If so, the method proceeds to step 510, where the subtransaction may be reverted by discarding the subtransaction's pending state in all participants. Alternatively, if the transaction in question is a top-level transaction, the method proceeds to step 512, where the transaction may be reverted by discarding its own pending state and any child subtransaction pending states in all participants. In an embodiment, a subtransaction may spawn child subtransactions. In this case, the subtransaction may be reverted by discarding the subtransaction's pending state and any child subtransaction pending states in all participants.

### Example Network Application Programming Interfaces (APIs)

Various embodiments may implement various application programming interfaces (API) to facilitate interaction among internal components, as well as with components external to the core system, as described with respect to FIGS. 1-5. According to an embodiment, there may be at least two APIs exposed to applications: the Query API, which is used to execute transactions and queries; and the Member API, which implements data storage and transaction events in system members. Additionally, in various embodiments, there may be various utility APIs.

The DTS Member API may act as an underside interface. Members may participate in transactions by registering with the Member API and implementing the needed callbacks. There are several different member application implementations possible, ranging from storing all data in the DTS Member API to storing all data in the application, with several hybrid modes in between.

The DTS Query API may act as an upper interface and may be a full multistep transaction API, implemented primarily by forwarding queries and updates to a local DTS Router. While queries may be conceptually implemented by forwarding to the local Router, the local Query API may evaluate new transactions enough to determine if only locally published, but totally unsubscribed, paths are referenced. In this case, the local Query API may avoid any messaging and directly implement the query's transaction under the control of the local Member API, according to an embodiment.

### Example Computer System

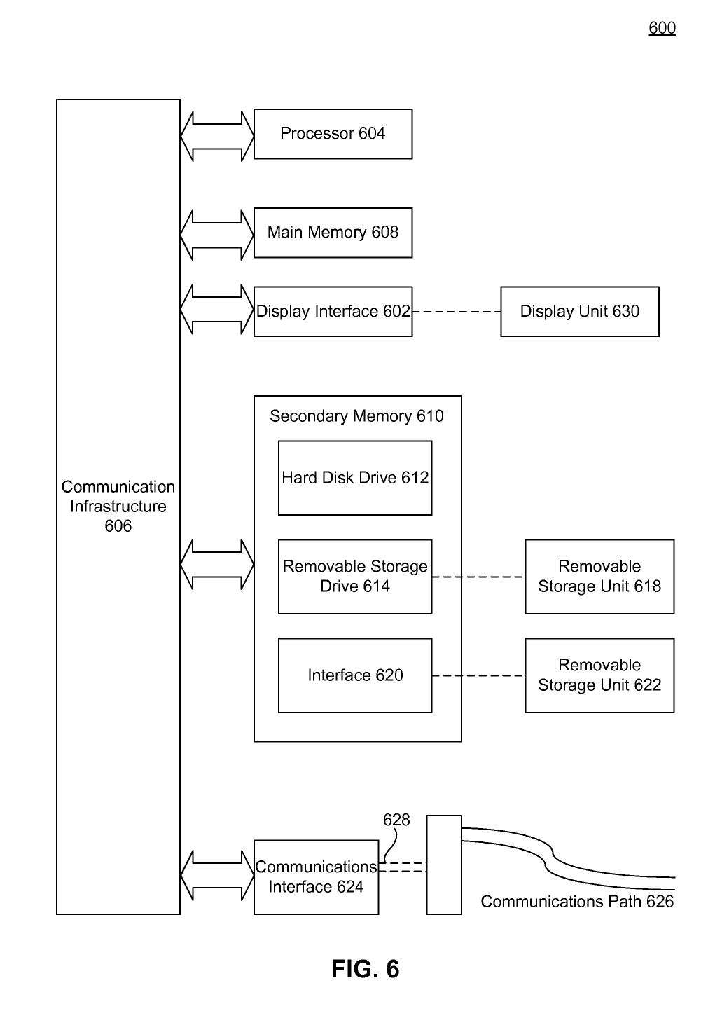

FIG. 6 is an example computing system useful for implementing various embodiments. Various embodiments can be implemented, for example, using one or more well-known computer systems, such as computer system 600. Computer system 600 can be any well-known computer capable of performing the functions described herein, such as computers available from International Business Machines, Apple, Sun, HP, Dell, Sony, Toshiba, etc.

Computer system 600 includes one or more processors (also called central processing units, or CPUs), such as a processor 604. Processor 604 may be connected to a communication infrastructure or bus 606.

One or more processors 604 may each be a graphics processing unit (GPU). In an embodiment, a CPU is a processor that is a specialized electronic circuit designed to rapidly process mathematically intensive applications on electronic devices. The CPU may have a highly parallel structure that is efficient for parallel processing of large blocks of data, such as mathematically intensive data common to computer graphics applications, images and videos.

Computer system 600 also includes user input/output device(s) 603, such as monitors, keyboards, pointing devices, etc., which communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614, Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/or any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 6. In particular, embodiments may operate with software, hardware, and/or operating system implementations other than those described herein.

### Conclusion

Identifiers, such as “(a),” “(b),” “(i),” “(ii),” etc., are sometimes used for different elements or steps. These identifiers are used for clarity and do not necessarily designate an order for the elements or steps.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore. such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described embodiments, but should be defined only in accordance with the following claims and their equivalents.

What is claimed is:

1. A system for managing the state of resources shared among a plurality of network nodes, comprising:
one or more computing devices;
one or more data store nodes that store a plurality of data objects within a network, wherein each data store node subscribes to at least one of the plurality of data objects;
one or more network nodes that subscribe to at least one of the plurality of data objects within the network; and
a transaction router, implemented on the one or more computing devices, configured to:
receive a transaction from a transaction provider, the transaction targeting one or more of the plurality of data objects; and
distribute the transaction to a first set of the one or more data store nodes and network nodes, wherein each of the first set of nodes subscribes to at. least one of the targeted data objects;
wherein the transaction is distributed to a second set of the one or more data store nodes and network nodes by the first set of nodes.

2. The system of claim 1, wherein the transaction router is further configured to:
assign a unique transaction identifier to the transaction;
reset a subtransaction level associated with the transaction; and
set a top-level transaction timeout value to a predetermined value;

3. The system of claim 1, further comprising:
a subtransaction router, implemented on the one or more computing devices, configured to:
receive a subtransaction from one of the one or more network nodes, the subtransaction targeting a subset of the data objects targeted by the transaction; and
distribute the subtransaction to a set of the one or more data store nodes and network nodes, wherein each of the set of nodes subscribes to at least one of the subset of data objects;
wherein the transaction does not complete until the subtransaction completes;

4. The system of claim 3, wherein the subtransaction router is further configured to:
increment a subtransaction level associated with the transaction; and
set a subtransaction timeout value to a predetermined value;

5. The system of claim 1, wherein the transaction router is further configured to:
receive an acknowledgement from each data store node and network node that receives the transaction,
wherein the transaction is committed when a positive acknowledgement has been received from every receiving data store node and network node.

6. The system of claim 5, wherein the transaction router is further configured to:
determine whether a positive acknowledgement has been received from each of the first set of nodes and the second set of nodes; and
abort the transaction when a transaction timeout value has expired and a positive acknowledgement has not been received from each of the first set of nodes and the second set of nodes,
wherein the transaction is aborted by discarding the pending state of the transaction and the pending state of associated subtransactions in each of the first set of nodes and the second set of nodes.

7. The system of claim 1, further comprising:
a resource manager, implemented on the one or more computing devices, configured to:
receive a request to allocate or reclaim resources within the network; and
execute the request.

8. The system of claim 1, wherein the transaction router is further configured to:
receive a plurality of transactions from one or more transaction providers;
aggregate the plurality of transactions into a single aggregated transaction, wherein the plurality of transactions are received within a predetermined period of time; and
distribute the single aggregated transaction to a set of the one or more data store nodes and network nodes, wherein each of the set of nodes subscribes to a data object targeted by at least one of the plurality of transactions.

9. The system of claim 1, wherein each data object contains at least one of network configuration and operational state data.

10. The system of claim 1, wherein the one or more data store nodes and the one or more network nodes interact with the transaction router via an application programming interface (API).

11. A method for managing the state of resources shared among a plurality of network nodes, comprising:
receiving a transaction from a transaction provider, the transaction targeting one or more data objects within a network; and
distributing the transaction to a first set of data store nodes and network nodes, wherein each of the first set of data store nodes and network nodes subscribes to at least one of the targeted data objects,
wherein each data store node stores a plurality of data objects within the network, and
wherein the transaction is distributed to a second set of data store nodes and network nodes by the first set of nodes.

12. The method of claim 11, further comprising:
assigning a unique transaction identifier to the transaction;
resetting a subtransaction level associated with the transaction; and
setting a top-level transaction timeout value to a predetermined value;

13. The method of claim 11, further comprising:
receiving a subtransaction from a network nodes, the subtransaction targeting a subset of the data objects targeted by the transaction; and
distributing the subtransaction to a set data store nodes and network nodes, wherein each of the set of nodes subscribes to at least one of the subset of data objects;
wherein the transaction does not complete until the subtransaction completes;

14. The method of claim 13, further comprising:
incrementing a subtransaction level associated with the transaction; and
setting a subtransaction. timeout value to a predetermined value;

15. The method of claim 11, further comprising:
receive an acknowledgement from each data store node and network node that receives the transaction,
wherein the transaction is committed when a positive acknowledgement has been received from every receiving data store node and network node.

16. The method of claim 15, further comprising:
determining whether a positive acknowledgement has been received from each of the first set of nodes and the second set of nodes; and
aborting the transaction when a transaction timeout value has expired and a positive acknowledgement has not been received from each of the first set of nodes and the second set of nodes,
wherein the transaction is aborted by discarding the pending state of the transaction and the pending state of associated subtransactions in each of the first set of nodes and the second set of nodes.

17. The method of claim 11, further comprising:
receiving a request to allocate or reclaim resources within the network; and
executing the request.

18. The method of claim 11, further comprising:
receiving a plurality of transactions from one or more transaction providers;
aggregating the plurality of transactions into a single aggregated transaction, wherein the plurality of transactions are received within a predetermined period of time; and
distributing the single aggregated transaction to a set of data store nodes and network nodes, wherein each of the set of nodes subscribes to a data object targeted by at least one of the plurality of transactions.

19. The method of claim 11, wherein each data object contains at least one of network configuration and operational state data.

20. A non-transitory computer-readable storage device having instructions stored thereon that, when executed by at least one computing device, causes the at least one computing device to perform operations comprising:
receiving a transaction from a transaction provider, the transaction targeting one or more data objects within a network; and
distributing the transaction to a first set of data store nodes and network nodes, wherein each of the first set of data store nodes and network nodes subscribes to at least one of the targeted data objects,
wherein each data store node stores a plurality of data objects within the network, and
wherein the transaction is distributed to a second set of data store nodes and network nodes by the first set of nodes.
